(19) United States
(12) Patent Application Publication
(10) Pub. No.: US 2018/0325206 A1
(43) Pub. Date: Nov. 15, 2018

(54) CUSTOM FIT MASK AND STRAP ASSEMBLY AND METHOD OF PRODUCING A CUSTOM FIT MASK AND STRAP ASSEMBLY

(71) Applicant: Carleton Technologies, Inc., Orchard park, NY (US)

(72) Inventors: William D. Siska, Alden, NY (US); Lucas P. Mesmer, Elma, NY (US)

(73) Assignee: Carleton Technologies, Inc.

(21) Appl. No.: 15/975,014

(22) Filed: May 9, 2018

Related U.S. Application Data
(60) Provisional application No. 62/504,268, filed on May 10, 2017.

(51) Int. Cl. A42C 2/00; A62B 18/04

(52) U.S. Cl. CPC A42C 2/007; A62B 18/04

(57) ABSTRACT

A method of producing a custom mask and strap assembly for an aviator's helmet, including: creating a custom mold using additive manufacturing based on at least two physiognomy parameters; forming the custom mask made of an elastomer from the custom mold; assembling the custom mask with a hard shell; and, securing the custom mask and the hard shell to the helmet by a strap assembly, the strap assembly including a strap anchor securable to the helmet and a strap slidably connected to the strap anchor. The strap includes a first side and a second side and further includes a first end securable to a first portion of the mask with the first side facing the mask and a second end securable to a second portion of the mask with the second side facing the mask.

### CROSS-REFERENCE TO RELATED APPLICATIONS

This application claims the benefit of U.S. Provisional Patent Application Ser. No. 62/504,268, filed on May 10, 2017 and entitled “Custom Fit Mask and Strap Assembly and Method of Producing a Custom Fit Mask and Strap Assembly”, the entire disclosure of which is incorporated herein by reference.

### FIELD OF THE INVENTION

The present disclosure relates generally to a custom fit mask and strap assembly which is removably securable to a helmet, and, more particularly, to a custom fit mask and strap assembly arranged to enable a person to easily and effectively attach and adjust the custom fit face mask. The present disclosure also relates generally to a method of producing a custom fit mask and strap assembly.

### BACKGROUND

In the aviation industry, aviators wear helmets and face masks to prevent injury and facilitate normal breathing. At higher altitudes, since there is less air pressure pilots wear face masks equipped with a source of oxygen to ensure they have sufficient oxygen to breathe. It is desirable to have a face mask that adequately seals against the aviator's face and is comfortable to wear. However, conventional face masks are typically uncomfortable and/or require additional material, for example, foam to prevent leaks proximate to the seal. Additionally, conventional methods for creating custom face masks are expensive and time consuming.

Traditional processes for producing custom face masks are vulnerable to complications during the molding process. For example, in processes where silicone is poured into a silicone mold, binding can occur between the poured silicone and the mold and the mask and the mold can be destroyed. A method of producing a custom fit mask that is accurate and more efficient is needed. There is also a need in the art for a method of producing a custom fit mask that is less expensive and less time consuming than traditional processes.

A harness, or a strap assembly, is typically used to secure a face mask to an aviator's helmet. For example, FIG. 14 shows a conventional face mask and strap assembly 1. The strap assembly 1 connects the face mask 2 with a helmet 3. The harness includes two straps A and B which are not connected to each other on either side of the mask 2, each strap extending between the face mask 2 and the helmet 3. Although not depicted in FIG. 14, the conventional strap assembly 1 includes two additional straps which are not connected to each other on the opposite side of the mask, each strap extending between the face mask and the helmet. To secure the mask effectively, a user must adjust each strap independently to ensure a proper seal and cant angle. Once the straps are adjusted and the mask is secured, the straps are designed to remain fixed at all times to ensure the mask remains secured.

However, such conventional strap assemblies are cumbersome to use and are inflexible. For example, when a user wearing the conventional face mask and helmet moves his/her face or head relative to the helmet, the positioning of the face mask relative to the helmet typically needs to be adjusted to account for the movement and maintain an effective and comfortable seal. To adjust the positioning of the face mask relative to the helmet, the user must manually adjust each strap independently. In this case, the user might have to adjust four different straps independently, two on each side of the mask. To adjust the vertical position of the mask relative to the helmet, a user must manually loosen the screws S on the helmet mounted anchor mechanism 4, rotate the anchor mechanism 4, and retighten the screws S. The vertical position of the mask can be adjusted only a minimal amount with the helmet mounted anchor mechanism. Moreover, when adjusting the vertical position of the mask relative to the helmet, it is usually also necessary to adjust the length of the straps on either side of the mask, each of which must be adjusted manually individually as discussed above.

The conventional strap assembly shown in FIG. 14 also notably includes an additional separate component between the helmet 3 and the mask 2, namely, a strap anchoring member 5, which is secured to the helmet mounted anchor mechanism 4. The strap anchoring member 5 may rest against the face of the user and includes two openings for anchoring the straps A and B. The strap anchoring member includes a plurality of metal pieces. For example, the strap anchoring member 5 includes eight metal pieces, however only some are visible. The number of metal pieces required for strap anchoring member 5 adds weight and cost to the overall assembly. Moreover, such additional components increase cost for manufacturing and assembly. Additionally, this component can cause irritation or discomfort to the person wearing the assembly.

Accordingly, there is a need in the art for a method of producing a custom fit mask and strap assembly that is comfortable to wear and provides an effective seal. There is also a need for a strap assembly that is easier to use and provides increased adjustability. There is a further need in the art for a strap assembly that provides a larger number of available vertical positions for the mask relative to the helmet. Additionally, a strap assembly that is lighter in weight and simpler in construction is needed. For example, there is a need in the art for a strap assembly that obviates the need for a strap anchoring member arranged between the helmet and the face mask.

### SUMMARY OF THE INVENTION

Generally, in one aspect, a method of producing a custom fit mask and strap assembly for an aviator's helmet is provided. The method includes the steps of (i) creating a custom mold using additive manufacturing based on at least two physiognomy parameters; (ii) forming the custom fit mask made of an elastomer from the custom mold; (iii) assembling the custom fit mask with a hard shell; and, (iv) securing the custom fit mask and the hard shell to the helmet by a strap assembly. The strap assembly includes a strap anchor releasably securable to the helmet, the strap anchor including a slot; and a strap slidably connected to the strap anchor. The strap includes a first side and a second side opposite the first side, the strap further including: a first end securable to a first portion of the custom fit mask with the first side facing the custom fit mask; and a second end securable to a second portion of the custom fit mask with the second side facing the custom fit mask. The strap is arranged to slide within the slot.

According to an embodiment, the step of creating the custom mold comprises creating a plurality of pieces that are securable together to form a unit.

According to an embodiment, the plurality of pieces is created using at least one of the following processes: material extrusion, material jetting, vat photopolymerization, powder bed fusion, and directed energy deposition.

According to an embodiment, the step of creating the custom mold using additive manufacturing comprises creating a custom hard positive mask using additive manufacturing such that the custom mold is created from the custom hard positive mask.

According to an embodiment, the custom hard positive mask is created with information obtained from a 3D scanner to create a facial surface file.

According to an embodiment, the step of securing the custom fit mask by the strap assembly comprises adjusting the strap within the slot of the strap anchor.

According to an embodiment, the step of adjusting the strap comprises sliding the strap within the slot of the strap anchor.

According to an embodiment, the second side of the strap contacts the slot.

According to an embodiment, the first and second portions are arranged on a first side of the mask.

According to an embodiment, further comprising the step of releasably securing the strap anchor to the helmet such that the strap anchor is adjustable when the strap anchor is released.

Generally, in another aspect, a method of producing a custom fit mask and strap assembly for an aviator's helmet, including the steps of: (i) creating a custom hard positive mask using additive manufacturing based on at least two physiognomy parameters; (ii) creating a custom mold from the custom hard positive mask; (iii) forming the custom fit mask made of an elastomer from the custom mold; (iv) assembling the custom fit mask with a hard shell; and, (v) securing the custom fit mask and the hard shell to the helmet by a strap assembly, the strap assembly including: a strap anchor releasably securable to the helmet, the strap anchor including a slot; and a strap slidably connected to the strap anchor, the strap having a first side and a second side opposite the first side, the strap further including: a first end securable to a first portion of the custom fit mask with the first side facing the custom fit mask; and a second end securable to a second portion of the custom fit mask with the second side facing the custom fit mask. The strap is arranged to slide within the slot.

Generally, in a further aspect, a strap assembly for securing a mask to an aviator's helmet is provided. The strap assembly includes: (i) a support member securable to a first side of the helmet, the support member including a slot; (ii) a strap anchor securable to the support member; and (iii) a strap slidably connected to the strap anchor, the strap having a first side and a second side opposite the first side, the strap further including: a first end securable to a first portion of the mask with the first side facing the mask; and a second end securable to a second portion of the mask with the second side facing the mask. The strap anchor is displaceable within the slot of the support member for adjustability.

According to an embodiment, the first end or the second end of the strap is connected to the mask via an adjustment buckle.

According to an embodiment, at least a portion of the second side of the strap contacts the slot.

According to an embodiment, the first and second portions of the mask are portions of a hard shell and the first and second portions are arranged on a first side of the mask.

According to an embodiment, the strap is a single continuous strap.

According to an embodiment, the strap anchor is releasably connected to the support member.

According to an embodiment, the mask is formed by a multi-piece mold using additive manufacturing based on at least two physiognomy parameters.

According to an embodiment, the mask is formed by a custom hard positive mask using additive manufacturing and a custom mold from the custom hard positive mask.

According to an embodiment, the mask includes an integrated custom seal.

According to an embodiment, the custom fit mask includes an integrated custom chin cup.

According to an embodiment, the strap anchor is slideable within the slot when being displaced.

According to an embodiment, once the custom mask and hard shell are secured to the helmet by the strap assembly, additional valve components, interconnects, and other hardware can be assembled.

According to an embodiment, the custom mold in the process involving the custom hard positive mask is a low volume silicon mold. For example, a silicon mold can be used to cast several silicone masks or up to approximately 10 urethane masks before wearing out.

According to an embodiment, the second end of the strap is connected to the second portion of the mask via the adjustment buckle and the second end forms a pull tab.

According to another aspect, a strap assembly is provided. The strap assembly includes (i) a first strap anchor securable to a first side of a helmet, the first strap anchor including a first slot; (ii) a first strap slidably connected to the first strap anchor, the first strap having a first strap side and a second strap side opposite the first strap side, the first strap further comprising: a first strap end securable to a first side portion of a mask with the first strap side facing the mask; and a second strap end securable to a second side portion of the mask with the second strap side facing the mask; wherein the first and second side portions of the mask are located on a same side of the mask; (iii) a second strap anchor securable to a second side of the helmet; and (iv) a second strap slidably connected to the second strap anchor and securable to the mask.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from the embodiments described below.

### BRIEF DESCRIPTION OF THE DRAWINGS

The foregoing will be apparent from the following more particular description of example embodiments of the present disclosure, as illustrated in the accompanying drawings in which like reference characters refer to the same parts throughout the different views. The drawings are not necessarily to scale, emphasis instead being placed upon illustrating embodiments of the present disclosure.

FIG. 1 is a perspective view of an example method of creating a surface file from a generated point cloud for a custom fit mask, in accordance with an embodiment of the present disclosure.

FIG. 2 is an example of physiognomy dimensions used with the surface file for a custom fit mask, in accordance with an embodiment of the present disclosure.

FIG. 3 is a graphical representation of height and width probability density functions for a custom fit mask, in accordance with an embodiment of the present disclosure.

FIG. 4 is a tabular representation of mask template size bounds for a custom fit mask, in accordance with an embodiment of the present disclosure.

FIG. 5 is an example of four custom mask templates, in accordance with an embodiment of the present disclosure.

FIG. 6 is a perspective view of an example process of forming a custom mask from a template, in accordance with an embodiment of the present disclosure.

FIG. 7 is a front view and a perspective view of a hard shell for a custom fit mask, in accordance with an embodiment of the present disclosure.

FIG. 8 is a partial exploded view of a four-piece mold for a custom fit mask, in accordance with an embodiment of the present disclosure.

FIG. 9 is a front view and a rear view of a four-piece molded mask, in accordance with an embodiment of the present disclosure.

FIG. 10 is a cross-sectional view of a paired valve configuration for a custom fit mask, in accordance with an embodiment of the present disclosure.

FIG. 11 is a perspective view, a bottom view, and a detailed view of the inhalation and exhalation valves of a custom fit mask, in accordance with an embodiment of the present disclosure.

FIG. 12 is a perspective view of a strap assembly connecting a custom fit mask with a helmet, in accordance with an embodiment of the present disclosure.

FIG. 13 is an enlarged perspective view of a strap assembly, in accordance with an embodiment of the present disclosure.

FIG. 14 is a perspective view of a typical strap assembly connecting a face mask with a helmet.

### DETAILED DESCRIPTION OF EMBODIMENTS

A description of example embodiments of the invention follows. Although the methods of producing a custom fit mask and strap assembly are shown and described using specific materials and processes, the present disclosure is not limited to these specific materials and processes. For example, the term “additive manufacturing” as used herein describes any manufacturing process which provides the results described, including, but not limited to material extrusion, material jetting, vat photopolymerization, powder bed fusion, and directed energy deposition. An example of material extrusion process is fuse deposition modeling (FDM) or any suitable alternative. Examples of material jetting processes include printers available from Solidscape, Inc. of Merrimack, N.H. and Stratasys headquartered in Eden Prairie, Minn., and any other suitable alternative 3D systems. The vat photopolymerization process includes stereolithography and machines with digital light processing (DLP) technology or any other suitable alternatives. The powder bed fusion process includes, but is not limited to the following commonly used printing techniques: electron beam melting (EBM), selective laser melting (SLM), and selective laser sintering (SLS), and any other suitable alternatives. Directed energy deposition processes direct energy to heat a substrate and melt the substrate while simultaneously melting material that is being deposited. Additionally, while urethane and silicone are described herein, any other suitable alternative materials can be used as well.

Moreover, it should be appreciated that the embodiments described herein which include a custom hard positive mask are distinct from the embodiments which do not include the custom hard positive mask. For the embodiments which do not include the custom hard positive mask, the processes use additive manufacturing to create a custom mold directly. In contrast, for the embodiments which include the custom hard positive mask, the mold is created indirectly based on the hard positive mask. In these embodiments, after the custom hard positive mask is created using additive manufacturing, a mold is created around the mask by covering the mask with a material which becomes firm enough to be detached from the mask and keep its custom shape. Once the mold is detached from the mask, an elastomeric molded part can be created by pouring urethane or silicone, for example, into the hollow space of the mold. The hollow space represents the negative of the mask. In the embodiments which do not include the custom hard positive mask, the mold is created directly using additive manufacturing obviating the need to create the custom mask, cover the mask with mold material, and detach the mold from the mask.

The example embodiments include a method of producing a custom fit mask and strap assembly for an aviator's helmet. The method broadly includes the steps of (i) creating a custom mold using additive manufacturing based on at least two physiognomy parameters; (ii) forming a custom fit mask made of an elastomer from the custom mold; (iii) assembling the custom fit mask with a hard shell; and, (iv) securing the custom fit mask and the hard shell to the helmet by a strap assembly. An advantage of the methods of producing a custom fit mask disclosed herein is that it obviates the need for traditional methods of casting for molding which involve complex chemical and thermodynamic interactions. It should be appreciated that in alternative embodiments, the hard shell can be dispensed with and any suitable alternative can be used instead. For example, a plurality of hard portions can be included within or added to the custom fit mask for purposes of securing the strap assembly.

In one example embodiment, the method of producing a custom fit mask and strap assembly includes a strap assembly having a strap anchor and a strap. The strap anchor is securable to the helmet and includes a slot. The strap is slidably connected to the strap anchor and includes a first side and a second side opposite the first side, a first end securable to a mask with the first side facing the mask and a second end securable to the mask with the second side facing the mask. The strap is arranged to slide within the slot. An advantage of the strap assemblies described herein is that they are easier to use and provides increased adjustability.

One object of the example embodiments is to provide a custom fit mask based on the physiognomy of individuals that is less expensive and easier to produce.

Still another object of the example embodiments is to provide a custom fit mask including a mask template based on physiognomy and a custom seal to user interface.

Yet another object of the example embodiments is to provide a custom fit mask that seals effectively and comfortably without having to evaluate multiple mask manufacturers and sizes or add additional foam around the sealing surface.

Another object of the example embodiments is to provide a process for producing a custom fit mask that includes a uniform wall thickness and does not contain air bubbles, tearing, or unwanted flash.

Still another object of the example embodiments is to provide a custom fit mask including inhalation and exhalation valving that minimizes weight, size, and breathing resistance.

Yet another object of the example embodiments is to provide a strap assembly that is lighter in weight and simpler in construction.

A further object of the example embodiments is to provide a strap assembly that provides a larger number of available vertical positions for a custom fit mask relative to a helmet.

Referring now to the drawings, wherein like reference numerals refer to like parts throughout, there is shown a step-by-step process for creating a custom fit mask and strap assembly for an aviator's helmet based on physiognomy and using additive manufacturing and short-run molding, for example. The method broadly includes the steps of: (i) acquiring a unique facial surface file; (ii) creating a custom mold using additive manufacturing based on the unique facial surface file; (iii) forming a custom fit mask made of an elastomer from the custom mold; (iv) assembling the custom fit mask with a hard shell; and, (v) securing the custom fit mask and the hard shell to the helmet by a strap assembly.

In an example embodiment, the method of producing a custom fit mask and strap assembly includes an additional step of creating a custom hard positive mask using additive manufacturing before a custom mold is created. In such an example embodiment, a custom mold is created from the custom hard positive mask.

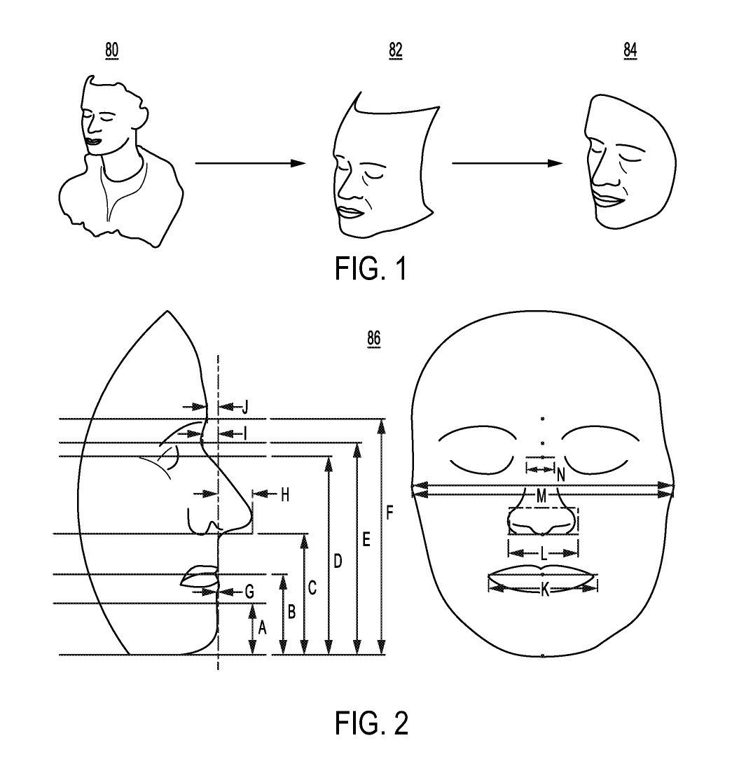

FIG. 1 shows a perspective view of an example method of creating a surface file from a generated point cloud using software. A 3D scanner can be used to capture human facial features to create a custom mask. Suitable scanners include the Artec Eva Lite (available from Artec 3D based in Luxembourg) or the Go!SCAN 50 (available from Creaform Inc. based in Québec, Canada). Using any suitable device, a geometric image of human facial features can be projected onto an object and the distortion of the image can be interpreted into XYZ points in space. Any suitable camera can be used to reference the object so that reference points are not needed. The object can be rotated in reference to the camera or vice versa. The output of the camera is a 3D point cloud in space which can include environment artifacts. In an example embodiment, the scanner is a handheld scanner used with any suitable laptop and structured white light light-emitting diode to capture the point cloud in space, the point cloud including geometric samples on the face of the aviator. Using reconstruction, for example, the shape of the face can be extrapolated from the points. In an example embodiment, a 3D scanner is employed for approximately 45 seconds to capture the point cloud. Using any suitable software program, the point cloud 80 can be visualized to determine whether sufficient data was captured by scanning. Additional scanning can be performed if necessary 82. The scanned image can be cropped, smoothed, and trimmed as deemed necessary. In an example embodiment, post-processing involves using software to overlay a single surface over the point cloud (like laying a thin sheet over a face). By itself the 3D point cloud is difficult to work with and software is required to post treat the point cloud to remove artifacts and smooth and generate surfaces for use in SolidWorks, for example. FIG. 1 shows a progression from a generation of an image using a suitable scanner to a creation of a surface file 84.

In an example embodiment, the process described herein is used to create a single custom fit mask and strap assembly. Alternatively, the process can be modified to create a plurality of custom fit assemblies using a set of mask templates as further described below.

For example, when creating custom fit assemblies for a group of aviators, a sampling of statistical data can be generated based on specific physiognomy measurements 86. Instead of creating individual masks which are entirely unique to each individual, a set of mask templates based on the specific facial dimensions of the group can be created to reduce the amount of modeling time required. Another advantage of creating a set of mask templates is that it enables a standardization of a series of hard shells to mate with the custom masks. For example, as shown in FIG. 2, physiognomy dimensions (A, B, C, D, E, F, G, H, I, J, K, L, M, and N) can be obtained from a group of aviators and, consistent with mask-fitting methodologies, a set of mask templates can be created based on height and width measurements. Height is defined as the distance in inches between E and A (nose bridge to chin dimple) and width K is defined as the distance between the sides of the mouth opening.

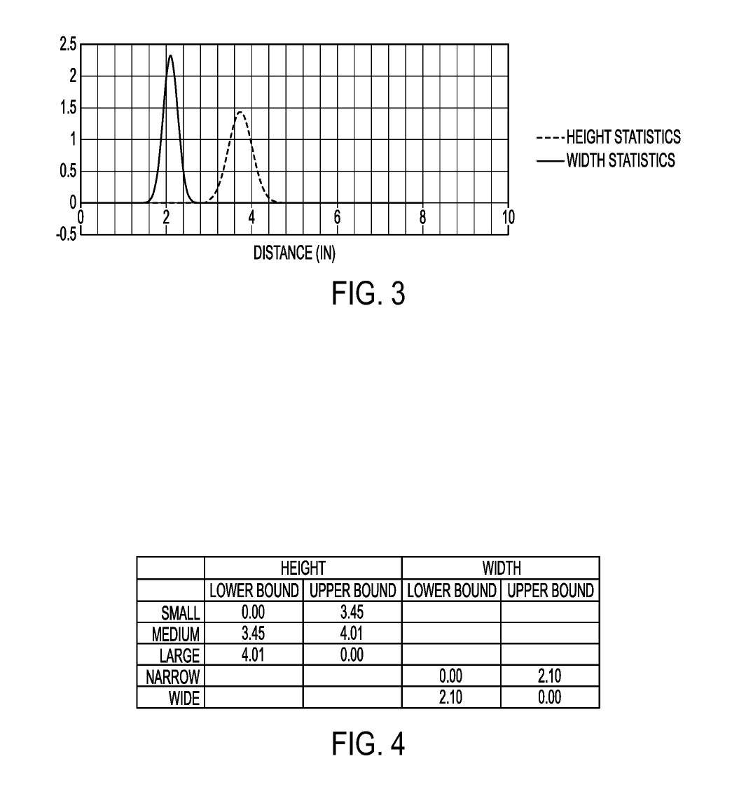

FIG. 3 shows a graphical representation of height and width probability density functions. In the example data shown in FIG. 3, the normal distribution for width is tighter than height. Based on the data, the individuals in a group can be custom fitted with a mask template based on their height and width measurement. For example, four mask templates can be created: small, medium-narrow, medium-wide, and large. Additional or fewer mask templates can be created. A medium size mask template satisfies users within 1 standard deviation of the average height measurement (68.2%). A small size mask template satisfies all users below 1 standard deviation (15.9%) from the average height. A large size mask template satisfies all users above 1 standard deviation from the average height (15.9%). The wide and narrow designations for medium are determined by the individual's width measurement. For example, users above the average width fall into the medium-wide size template, and users below the average width fall into the medium-narrow size template.

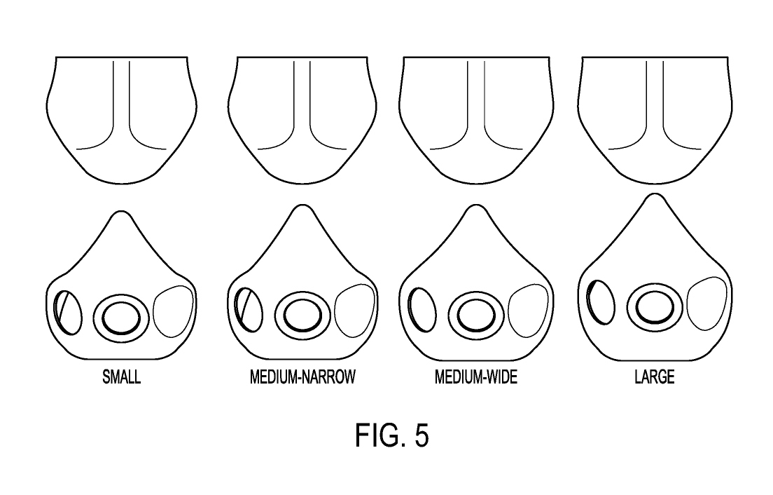

FIG. 4 is a tabular representation of mask template size bounds. Each individual to be fitted with a custom fit mask can be categorized into one of the four mask templates using the specific physiognomy measurements of each individual. For example, an individual having a height of 3.52 in and a width of 2.30 in would be appropriately fitted with a medium-wide mask template. A person having a height of 3.56 in and a width of 1.74 in would be appropriately fitted with a medium-narrow mask template. A person having a height of 4.13 in and a width of 2.15 in would be appropriately fitted with a large mask template. A person having a height of 3.40 in and a width of 2.01 in would be appropriately fitted with a small mask template.

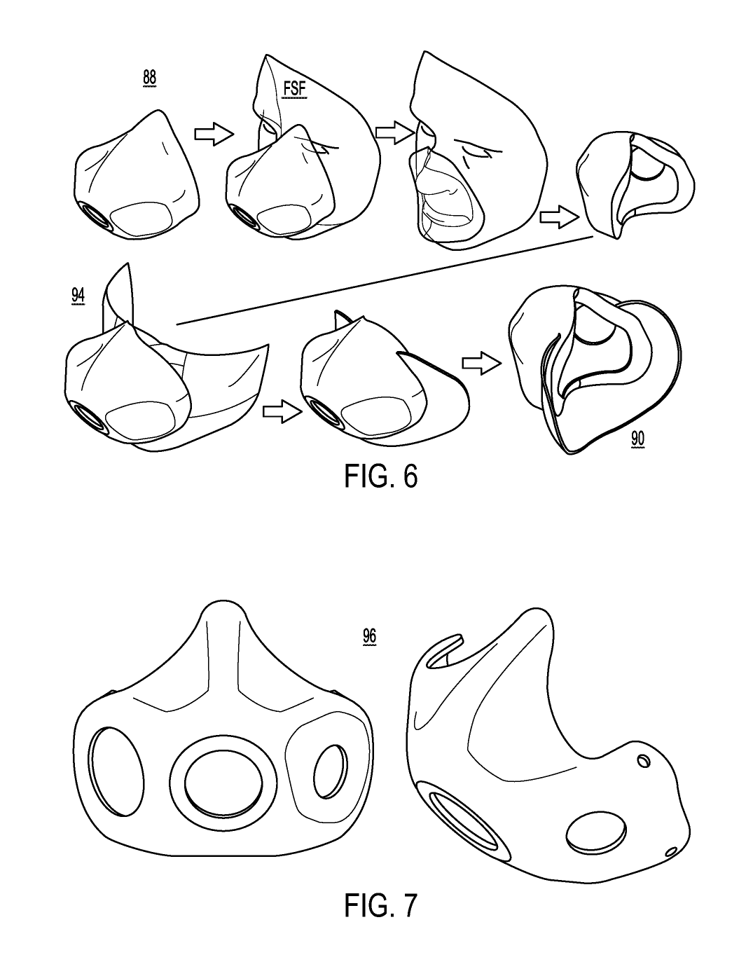

FIG. 5 is an example of four custom mask templates which can be created to accommodate all of the individuals in a group based on the physiognomy analysis and trial and error. SolidWorks Surface can be used to design the four custom mask templates. Each template includes standard ports for inhalation and exhalation valves and can be assembled with mating hard shells. Each template can be used to generate unique sealing surfaces and chin cups for each individual. The templates depicted in FIG. 5 are not fixed and can be altered for any mask scenario. For example, although the mask templates in FIG. 5 include an inhalation tube centered on the mask to prevent head whiplash during ejection, the position of the inhalation tube can be moved.

In an example embodiment, the time to scan and post-process the 3D point is approximately 15 minutes. After the mask templates are created, the time needed to customize the mask for each person is approximately 2-3 hours. FIG. 6 is a perspective view of an example process of forming a custom fit mask 90 from a mask template 88. The mask template 88 is shown in the first state. Then, the mask template is applied to the facial surface file FSF in the second state. Using the image of the face, the mask can be cropped for customization and other parameters can be adjusted accordingly. A seal and/or a chin cup can be added as well for customization and utilization. In the third state, a unique seal 92 is configured on the facial surface file. Thereafter, the unique seal is combined with the mask template. Next, a customizable chin cup 94 is created based on the facial surface file and the mask template. A final model is created in the last state.

After the custom fit mask model is created, an elastomeric molded custom fit mask can be created. One technique is to create an elastomeric molded part through the use of poured urethane or silicone. One method involves the use of stereolithography to print the model of the part, which is subsequently smoothed in post processing. The printed model can be used as a pattern to make a mold whereby liquid urethane or silicone is introduced into the model and left to set. An alternative technique is to create an elastomeric molded part directly using stereolithography or any suitable alternative such that no model is needed and liquid urethane or silicone is not needed. The urethane or silicone part can be made of any suitable durometer (i.e., hardness) or color. In an example embodiment, an elastomeric molded custom fit mask can be created by a 3D printing technology that uses high-resolution ink-jet type technology to produce layers of liquid photopolymer to build models and prototypes with complex geometries, for example, PolyJet technology. Other example embodiments use other processes for creating three-dimensional objects using a computer-controlled moving laser beam to build up the structure, layer-by-layer, from a liquid polymer that hardens on contact with laser light. Any other process that achieves the same result is contemplated.

In an example embodiment, a PolyJet elastomer is used to create a custom fit mask that is foam-like rather than elastomeric. Although the material can be pungent, the PolyJet technology is efficient. In another example embodiment, a custom fit mask can be made of one or more relatively soft polymers (e.g., urethane 55 or silicone 60 Shore A). Any suitable material having any suitable hardness (i.e., durometer) can be used depending on the application and materials used. For example, in some embodiments, a silicone measuring 50 Shore A or 70 Shore A might be appropriate while any other suitably flexible silicone is also contemplated. While urethane 55 is more elastomeric than the PolyJet elastomer, the urethane also can be pungent. Even when the process involves vacuum baking of the masks, the material still exhibits a pungent odor. Silicone 60 Shore A is appropriately elastomeric and nearly odorless in an example embodiment. However, silicone 60 Shore A is more difficult to mold than urethane 55 Shore A due to binding.

FIG. 7 is a front view and a perspective view of a hard shell for a custom fit mask, in accordance with an embodiment of the present disclosure. A hard shell as shown in FIG. 7 can be created using stereolithography or any suitable alternative. The hard shell can be required to conduct fit testing and support the custom fit mask. To determine the quantitative fit of the custom fit mask, a Portacount Respirator Fit Tester 8038 (available from TSI, Inc.) can be used. In an example embodiment, the respirator fit tester measures the number of particles in the mask and compares them to the number of particles in ambient air to obtain a fit factor. The following equation can be used:

$$F F = \frac{{C}_{B} + {C}_{A}}{2 {C}_{R}}$$

where FF=fit factor; C_{B}=particle concentration in the ambient sample before the respirator sample; C_{A}=particle concentration in the ambient sample after the respirator sample; and C_{R}=particle concentration in the respirator sample. The overall fit factor can be obtained by the following equation:

$$Overall F F = \frac{n}{\frac{1}{F {F}_{1}} + \frac{1}{F {F}_{2}} + \frac{1}{F {F}_{3}} + … + \frac{1}{F {F}_{n - 1}} + \frac{1}{F {F}_{n}}}$$

where FFₓ=fit factor for test cycle and n=number of test cycles (exercises).

In an example embodiment, a standard (for example, 29 C.F.R. 1910.134—Respiratory Protection used by the Occupational Safety and Health Administration) is used for the fit factor testing and the following exercises are tested sequentially: normal breathing, deep breathing, head side-to-side, head up-and-down, talking out load, grimace, bend and touch toes, and normal breathing. The test for normal breathing involves the wearer remaining still and breathing as usual. The test for deep breathing involves the wearer taking long deep breaths to simulate working hard. The test for head side-to-side involves the wearer breathing normally while slowly turning the head from side-to-side. Each cycle from left to right should take several seconds, pausing momentarily at each side to take a breath. The test for head up-and-down involves the wearer breathing normally while slowly alternating between looking up toward a ceiling and down toward a floor. Each up and down cycle should take several seconds. The test for talking out loud involves the wearer reading a prepared paragraph or counting out load. The test for grimace involves the wearer smiling and/or frowning to attempt to create a leak in the face seal. This exercise often results in a failed fit factor, which is why some standards allow the exclusion of that fit factor when computing the overall fit factor. When performing the grimace test, the object is to intentionally create a break in the face seal to see if the mask re-seals itself after breaking the seal. Successful re-sealing is proven by achieving a passing fit factor on the following exercise. The next exercise involves the wearer bending at the waist while breathing normally. The last exercise involves the wearer remaining still and breathing normally.

Each of the exercises described above samples in the following sequence: 4 seconds of ambient purge time; 5 seconds of ambient sample time; 15 seconds of mask purge time; and 40 seconds of mask sample time. The exception is the grimace exercise which includes 15 seconds of mask sampling.

In an example embodiment, each custom fit mask can be fitted with an adapter to accommodate a P100 filter. These filters meet the requirement (pursuant to 42 C.F.R. part 84) for a minimum efficiency of 99.97% including oil aerosols. In addition, each custom fit mask can include inhalation and exhalation test valves as well as a sample port. Hans Rudolph Medium size head harnesses can be fitted to the hard shell or any other suitable alternative.

Advantageously, the custom fit mask described herein provides an improved seal when compared with typical masks which often require the addition of foam around the sealing surface to prevent leaks.

In an example embodiment, the field of view of a person fitted with a custom fit mask can be determined digitally using the digital facial surface file and the digital file of the custom mask for the person. The digital testing of the field of view obviates the need for a testing apparatus and eliminates test setup variations and subject mis-indication of light sensing. Field of view can be determined for each individual fitted with a custom fit mask. The center of the eye can be estimated and then a point can be taken 0.100″ into the eyeball and the center can be found between to represent the center of the field of vision (just behind the nose bridge). Field of view can be measured between 255° and 105° at 15° increments since this can be the area affected by the mask.

In an example embodiment, a custom fit mask can be created by pouring silicone around a 3D printed mask pattern, removing the mask, and pouring an elastomeric mask in its place or by creating a 3D printed elastomeric mold directly. Using the liquid silicone after printing, the mask can be sanded and smoothed with self-leveling primer. A plunger device can be used to fill the mold under light pressure. It is desirable to produce a custom fit mask without air pockets, inconsistent seal thickness, or tears which can occur by pouring silicone around a 3D printed mask pattern, removing the mask, and pouring an elastomeric mask in its place. Thus, it is advantageous to create a multi-piece custom mold directly using additive manufacturing.

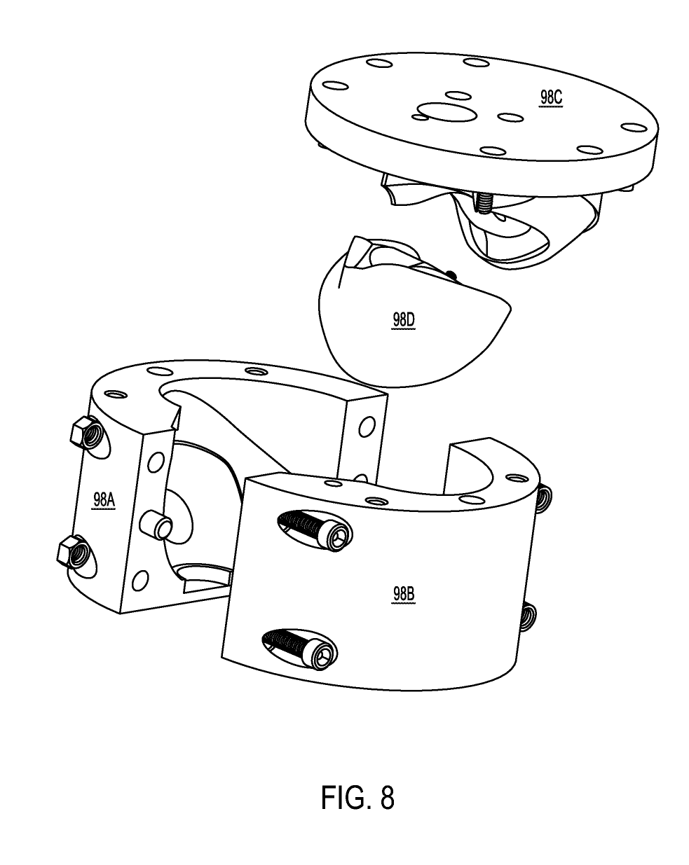

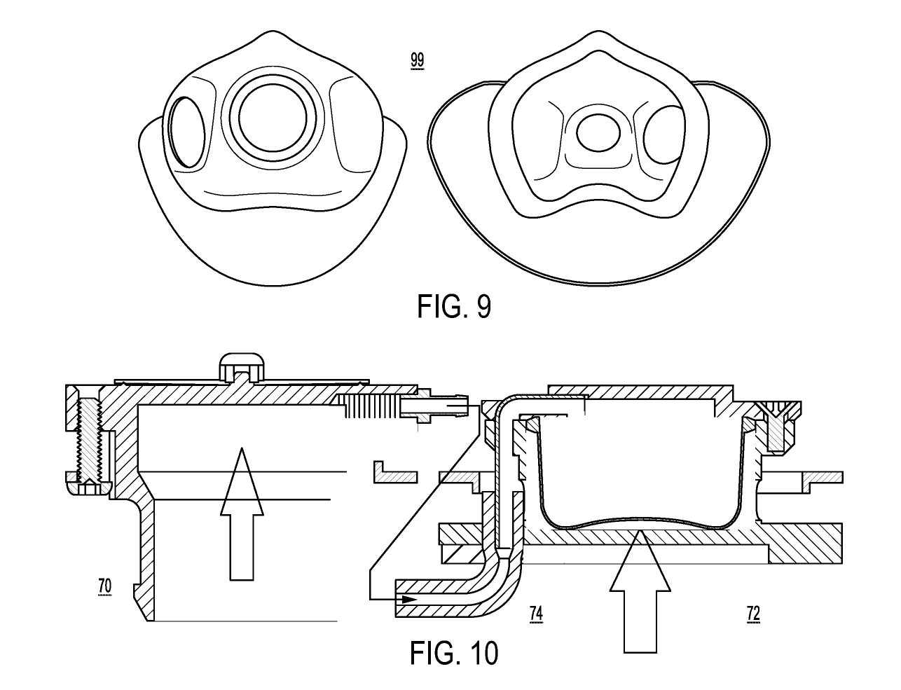

In an example embodiment, the entire mold can be printed using a fused deposition modeling (FDM) printer or other additive manufacturing methods described herein such that the mold is created in four separate pieces (as shown in FIG. 8). FIG. 8 is a partial exploded view of a four-piece mold 98A, 98B, 98C, and 98D, in accordance with an embodiment of the present disclosure. The mold can be designed in software, for example, a solid modeling computer-aided design program using the custom fit mask file. Parts of the mold can be printed at lower densities; however, after the second use these parts delaminated. If every piece is solid, the total volume is approximately 160 in³. Using the FDM four-piece mold, a custom fit mask can be created with minimal air bubbles, tearing, non-uniform wall thickness, and unwanted flash. A parting line forms down the middle of the part. FIG. 9 is a front view and a rear view of a four-piece molded mask 99, in accordance with an embodiment of the present disclosure.

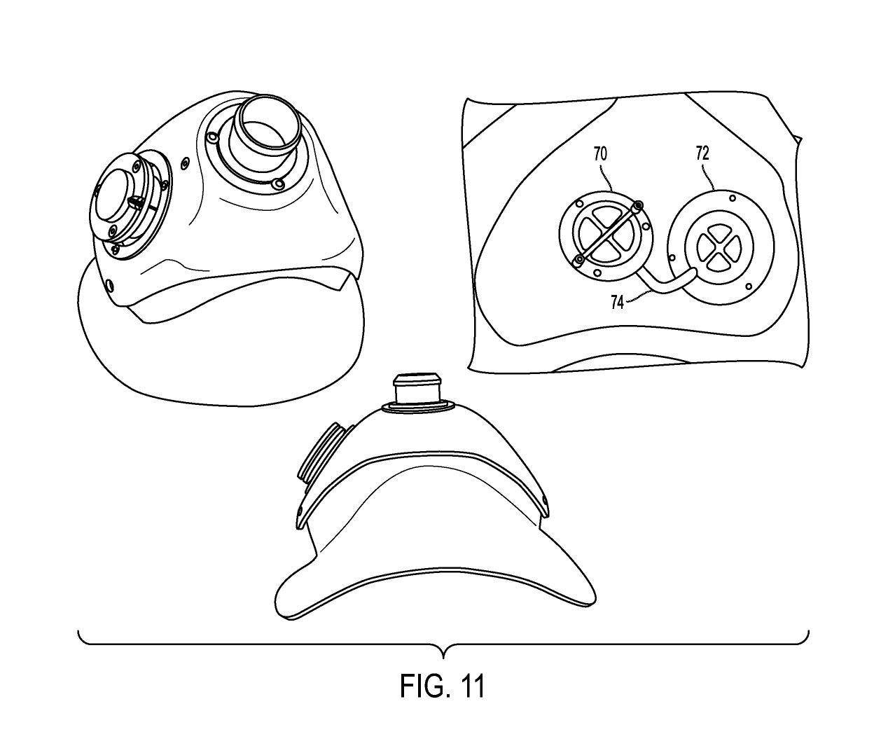

Paired inhalation and exhalation valves can be used with the custom fit mask as described herein. FIG. 10 is a cross-sectional view of a paired valve configuration, in accordance with an embodiment of the present disclosure. A paired valve configuration can be used in pressure breathing applications where the exhalation valve should be balanced by the inhalation gas pressure. As shown in FIG. 10, the tube gas from the inhalation valve 70 can be ported to the backside of the exhalation valve 72. The arrows in FIG. 10 represent the direction of flow. The exhalation valve is balanced by attaching the tube 74 to the nipple. In an example embodiment, the inhalation valve uses a simple flapper valve while the exhalation valve includes a custom silicone diaphragm. Any suitable alternatives can be used instead or additionally. FIG. 11 is a perspective view, a bottom view, and a detailed view of the inhalation and exhalation valves, in accordance with an embodiment of the present disclosure.

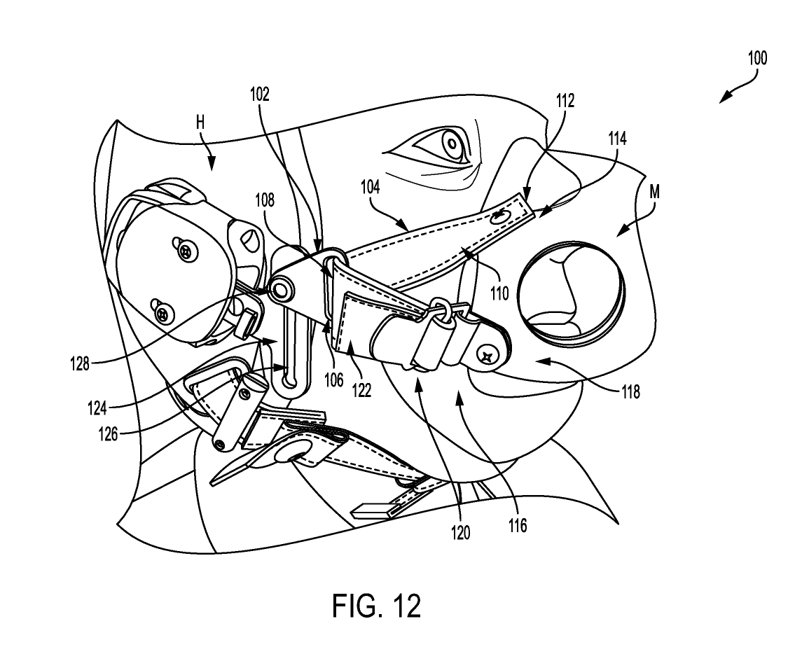

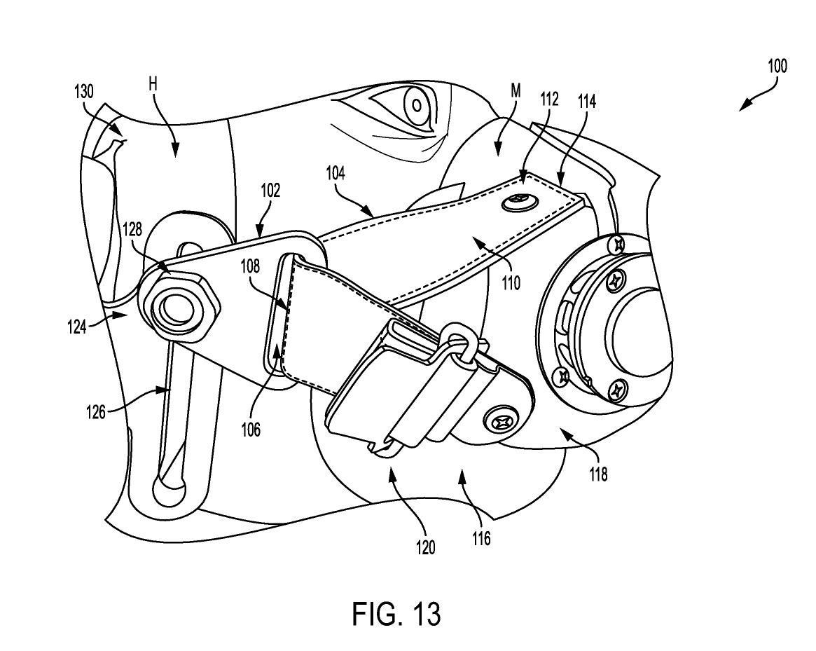

In FIG. 12 a perspective view of a strap assembly 100 according to an example embodiment of the present disclosure is shown. An enlarged perspective view of the strap assembly according to an example embodiment of the present disclosure is shown in FIG. 13. The following should be viewed in light of FIGS. 12 and 13. The strap assembly 100 connects a custom face mask (for example, the custom fit mask discussed herein) with a helmet in accordance with embodiments of the present disclosure. It should be appreciated that the example embodiments are not limited to the face mask or helmet depicted. Any suitable face mask or helmet can be used with the strap assembly 100. The strap assembly 100 broadly includes a strap anchor 102 and a strap 104. The strap anchor 102 is securable to a helmet H and includes a slot 106. The strap 104 is slidably connected to the strap anchor 102 and includes a first side 108 and a second side 110 opposite the first side 108, a first end 112 securable to a first portion 114 of a mask M with the first side 108 facing the mask M and a second end 116 securable to a second portion 118 of the mask M with the second side 110 facing the mask M. The strap 104 is arranged to slide within the slot 106.

The first and second portions 114 and 118 of the mask M are arranged on one side of the mask such that a single strap, namely, strap 104 can be used to secure one side of the mask in place while allowing a user the ability to make adjustments to the one side by adjusting a single strap. In one embodiment, the mask is secured to the helmet with an additional strap assembly on the other side of the mask. The mask M depicted in the figures has two sides including one side arranged on the left side of the face of the person wearing the mask and another side on the right side of the face of the person wearing the mask. The strap 104 is connected to portions 114 and 118 on the side of the mask which is positioned on the right side of the face of the person wearing the mask (from the perspective of the wearer).

In an embodiment, the strap 104 is a single continuous strap. In an embodiment, the strap 104 is formed of at least two straps connected together where at least one strap is adjustable for both straps as discussed herein.

In an embodiment, the strap 104 is slideable through the strap anchor 102 as a user moves his/her face or head relative to the helmet without the user having to manually adjust the assembly. Strap 104 can facilitate the effective seal and comfort as discussed above with respect to the fit testing involving the wearer moving his/her head from side-to-side and/or up and down.

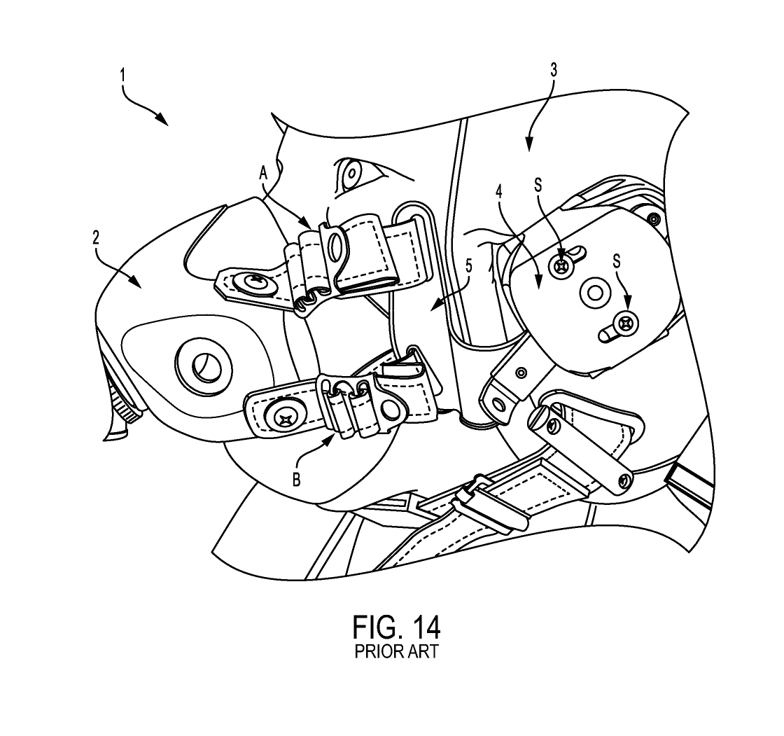

Due to the configuration of the strap assembly 100, there is no need for a separate strap anchor 5 which may or may not rest against the face of the user arranged between the helmet and the face mask as is necessary in the conventional assembly shown in FIG. 14. Advantageously, the strap assembly 100 occupies less amount of space of the face of the user and a fewer number of parts.

The strap assembly 100 can include an adjustment buckle 120 securing the first end 112 or the second end 116 of the strap 104 to the mask. In the embodiment shown in FIGS. 12 and 13, the second end 116 of the strap 104 is connected to the second portion 118 of the mask via an adjustment buckle 120 and the second end 116 of strap 104 forms a pull tab 122 to adjust the length. Any suitable alternative can be used in place of a pull tab. In FIG. 13, the pull tab 122 is rolled up so that it does not obstruct the view of the strap 104 in the assembly 100. To adjust the strap, the strap can be slid within the slot of the strap anchor and the end of the strap can be pulled through the buckle to maintain the adjustment.

As mentioned above, the strap 104 is arranged to slide within the slot 106. The second side 110 of the strap is arranged to contact and slide within the slot 106. In an embodiment, a roller device (not shown) can be included to facilitate the strap 104 sliding with ease in slot 106. Any suitable roller device is contemplated.

The mask can include a hard shell. For example, the first and second portions 114 and 118 of the mask M can be portions of a hard shell. It can be advantageous to secure the strap 104 in place between a secure strap anchor 102 and a hard shell of the mask.

According to an embodiment, the strap assembly 100 can include a support member 124 having a slot 126 where the strap anchor 102 is connected to the helmet via the support member 124. In an example embodiment, the strap anchor 102 is connected to the support member 124 with a screw and a hex nut 128. The hex nut 128 is keyed within the support member 124. Loosening the hex nut 128 on the outside of the strap anchor 102 allows a user to displace the strap anchor along the slot 126 to maximize adjustability and user comfort. Tightening the nut 128 secures the position of the strap anchor 102 within the slot 126 of support member 124. In an embodiment, the strap anchor 102 can be described as being releasably securable to the slot 126 because the nut 128, or any alternative, is releasable or loosenable as described herein. In an example embodiment, the strap anchor 102 and/or the support member 124 are made of a suitable carbon fiber for its strength and light weight qualities. Any suitable materials with the same characteristics may be used instead. Strap 104 can be made of any suitable material, for example, a woven fabric.

According to another aspect, a strap assembly 100 including: (i) a first strap anchor 102 securable to a first side 130 of the helmet, the first strap anchor including a first slot 106; (ii) a first strap 104 slidably connected to the first strap anchor 102, the first strap 104 having a first strap side 108 and a second strap side 110 opposite the first strap side 108, the first strap 104 further including: a first strap end 112 securable to a first side portion 114 of the mask with the first strap side 108 facing the mask; and a second strap end 116 securable to a second side portion 118 of the mask with the second strap side 110 facing the mask wherein the first and second side portions 114 and 118 of the mask are on a same side of the mask; (iii) a second strap anchor (not shown) securable to a second side of the helmet (opposite the first side of the helmet shown); and (iv) a second strap (not shown) slidably connected to the second strap anchor and securable to the mask.

Advantageously, the strap assembly 100 obviates the need for an additional strap anchoring member which can cause skin irritation and/or discomfort, increased production cost and assembly requirements. Additionally, the strap assembly 100 is easier to use than conventional strap assemblies in the relevant art. The strap assembly also provides increased adjustability by enabling a user to achieve additional vertical positions for the mask relative to the helmet. Moreover, the strap assembly is lighter in weight and simpler in construction as compared with conventional systems.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

What is claimed is:

1. A method of producing a custom fit mask and strap assembly for an aviator's helmet, comprising the steps of:
creating a custom mold using additive manufacturing based on at least two physiognomy parameters;
forming the custom fit mask made of an elastomer from the custom mold;
assembling the custom fit mask with a hard shell; and,
securing the custom fit mask and the hard shell to the helmet by a strap assembly, the strap assembly comprising:
a strap anchor releasably securable to the helmet, the strap anchor including a slot; and
a strap slidably connected to the strap anchor, the strap having a first side and a second side opposite the first side, the strap further comprising:
a first end securable to a first portion of the custom fit mask with the first side facing the custom fit mask; and
a second end securable to a second portion of the custom fit mask with the second side facing the custom fit mask;
wherein the strap is arranged to slide within the slot.

2. The method of claim 1, wherein the step of creating the custom mold comprises creating a plurality of pieces that are securable together to form a unit.

3. The method of claim 2, wherein the plurality of pieces is created using at least one of the following processes: material extrusion, material jetting, vat photopolymerization, powder bed fusion, and directed energy deposition.

4. The method of claim 1, wherein the step of creating the custom mold using additive manufacturing comprises creating a custom hard positive mask using additive manufacturing such that the custom mold is created from the custom hard positive mask.

5. The method of claim 4, wherein the custom hard positive mask is created with a 3D scanner to create a facial surface file.

6. The method of claim 1, wherein the step of securing the custom fit mask by the strap assembly comprises sliding the strap within the slot of the strap anchor.

7. The method of claim 1, wherein the second side of the strap contacts the slot.

8. The method of claim 1, wherein the first and second portions are arranged on a first side of the custom fit mask.

9. The method of claim 1, further comprising the step of releasably securing the strap anchor to the helmet such that the strap anchor is adjustable when the strap anchor is released.

10. A method of producing a custom fit mask and strap assembly for an aviator's helmet, comprising the steps of:
creating a custom hard positive mask using additive manufacturing based on at least two physiognomy parameters;
creating a custom mold from the custom hard positive mask;
forming the custom fit mask made of an elastomer from the custom mold;
assembling the custom fit mask with a hard shell; and,
securing the custom fit mask and the hard shell to the helmet by a strap assembly, the strap assembly comprising:
a strap anchor releasably securable to the helmet, the strap anchor including a slot; and
a strap slidably connected to the strap anchor, the strap having a first side and a second side opposite the first side, the strap further comprising:
a first end securable to a first portion of the custom fit mask with the first side facing the custom fit mask; and
a second end securable to a second portion of the custom fit mask with the second side facing the custom fit mask;
wherein the strap is arranged to slide within the slot.

11. A strap assembly for securing a mask to an aviator's helmet, the strap assembly comprising:
a support member securable to a first side of the helmet, the support member including a slot;
a strap anchor securable to the support member; and
a strap slidably connected to the strap anchor, the strap having a first side and a second side opposite the first side, the strap further comprising:
a first end securable to a first portion of the mask with the first side facing the mask; and
a second end securable to a second portion of the mask with the second side facing the mask;
wherein the strap anchor is displaceable within the slot of the support member for adjustability.

12. The strap assembly of claim 11, wherein the first end or the second end of the strap is connected to the mask via an adjustment buckle.

13. The strap assembly of claim 11, wherein at least a portion of the second side of the strap contacts the slot.

14. The strap assembly of claim 11, wherein the first and second portions of the mask are portions of a hard shell and the first and second portions are arranged on a first side of the mask.

15. The strap assembly of claim 11, wherein the strap is a single continuous strap.

16. The strap assembly of claim 11, wherein the strap anchor is releasably connected to the support member.

17. The strap assembly of claim 11, wherein the mask is formed by a multi-piece mold using additive manufacturing based on at least two physiognomy parameters.

18. The strap assembly of claim 11, wherein the mask is formed by a custom hard positive mask using additive manufacturing and a custom mold from the custom hard positive mask.

19. The strap assembly of claim 11, wherein the mask comprises an integrated custom seal.

20. The strap assembly of claim 11, wherein the mask comprises an integrated custom chin cup.
